(19) United States
(12) Patent Application Publication
(10) Pub. No.: US 2008/0201291 A1
(43) Pub. Date: Aug. 21, 2008

(54) Personnel accounting system

(76) Inventors: John W. Fussner, Mason, OH (US); Mark A. Woods, Morrow, OH (US)

Correspondence Address: Mark F. Smith, 905 Ohio Pike, Cincinnati, OH, 45245, US

(21) Appl. No.: 11/707,828

(22) Filed: Feb. 16, 2007

(51) Int. Cl. G06F 17/30

(52) U.S. Cl. 707/1; 707/E17.001

(57) ABSTRACT

The present invention provides a distinct advance in the state of the art. The personnel accounting system for efficiently accounting of individuals after or or during an event, such as a natural disaster or during an emergency, preferably is a computer-aided system that operates to provide an improved communication system whereby individuals can be identified, tracked, monitored in real time using a central processing and communication system and collectively stores and manages information pertinent to individuals affected by the event.

### BACKGROUND OF THE INVENTION

The present invention is directed to a personnel accounting system and more particularly, to a personnel accounting system for efficiently accounting for individuals after an event or during an emergency.

In an emergency, such as those caused by events such as fire, floods, earthquakes, snow storms, hurricanes, tornadoes, and the like, it is important to effectively and quickly identify individuals who may be in the area of the disaster and to confirm their location and condition during the performance of emergency operations. Often, when such an emergency event occurs, individuals are not at their expected locations. Further, individuals after the occurrence of an event or during an emergency may become separated and transported to various locations, such as hospitals, rescue stations, and temporary shelters. Depending on the nature of the emergency, individuals are often evacuated to safe areas prior to the occurrence of the disaster.

Emergency personnel often engage in extensive search and rescue operations looking for individuals who later are found not to have been in danger or in the area of the emergency. Further, emergency personnel are often overwhelmed by outside inquiries for information concerning the location and condition of individuals who were in the area of the emergency and who continue to be missing or have been transferred to a safe location. Such inquiries are made both by emergency personnel as well as concerned individuals, such as family members, friends, and the like.

Various systems have been developed to assist in tracking emergency personnel at a location. Systems have also been developed that notify individuals of the occurrence of an emergency or for confirming the safety of individuals who have the possibility of encountering the damage of the disaster when the disaster occurred. One such system is described in U.S. Pat. No. 7,174,150 to Shida and shows a system that operates by receiving information of a disaster occurring at a location. The system then operates to transmit a disaster notice to subscribers at the location and waits for a safety confirmation response and judges if the subscriber is in a safe state.

Unfortunately, systems have not been developed that creates or provides a listing of individuals and identifies individuals that are expected to be at or near a defined location area; that permits on-going additions or subtractions from that list; that allows important information concerning such individuals to be readily available; allows the location and condition of individuals to be inputted and updated on an on-going basis; and permits users to obtain information about the location and condition of those that have or may have been in the defined location area.

### SUMMARY OF THE INVENTION

The personnel accounting system for efficiently accounting of individuals during or after an event, such as a natural disaster or during an emergency, preferably is a computer-aided system that operates to provide an improved communication system whereby individuals can be identified, tracked, monitored in real time using a central processing and communication system and collectively stores and manages information pertinent to individuals affected by the event. The personnel accounting system comprises a central processing and communication system for storing information concerning individuals; means for identifying and listing individuals that may be within a defined location area; means for transmitting said listing of individuals to emergency personnel; means for continuously updating the information about individuals on said listing of individuals; and means whereby users can request information concerning individuals on said listing of individuals; means whereby users can add or subtract individuals on said listing of individuals.

In another preferred embodiment of the invention the central processing and communication system comprises a central computer having a controller and processor and memory for maintaining one or more databases; wherein the central computer operates system software that functions as an interactive system for guiding a user to enter information and storing the information in one or more of the databases; and wherein the system software operates to permit users to request information about individuals.

In another preferred embodiment of the invention the personnel accounting system further comprises means for automatically communicating updates about one or more individuals to a user.

In a preferred embodiment of the invention the personnel accounting system comprises a central processing and communication system comprising a central computer having a controller and processor and memory for maintaining one or more databases; wherein the central computer operates system software that functions to receive information about individuals and electronically store the information in one or more of the databases; wherein the system software identifies individuals listed to be within a defined location area; wherein the system software functions as an interactive system for guiding a user to enter updated information about individuals and storing the information in one or more of the databases; wherein the system software functions to compare information about identified individuals listed to be within a defined location area with updated information; and wherein the system further comprising means for verifying the updated information.

In another preferred embodiment of the invention the personnel accounting system further comprises means for permitting users to request updated information about one or more individuals.

In another preferred embodiment of the invention the personnel accounting system further comprises means for communicating updated information to the users requesting updated information about one or more individuals.

Another preferred embodiment of the invention the personnel accounting system comprises a central processing and communication system comprising a central computer having a controller and processor and memory for maintaining one or more databases; a communications server coupled to the central computer that operates to connect the system to one or more outside communication systems; wherein the processor being capable of performing the following operations: initializing a location database, wherein the location database includes a listing of individuals and the location of the individuals; continuously updating of the location database; identifying and preparing a listing of individuals within a defined location area; receiving new information concerning individuals and adding or subtracting individuals to the listing of individuals; receiving request for information for individuals on the listing of individuals; and providing and transmitting the requested information.

In another preferred embodiment of the invention the processor further being capable of performing the operation of verifying the new information.

In another preferred embodiment of the invention, the system further comprises means for automatically transmitting updated information to a requester.

In another preferred embodiment of the invention is a method for the accounting of individuals after or during or after an event, the method comprises the steps of: receiving information concerning an event; defining an event location area; identifying individuals from a listing of individuals who may be in the event location area; providing emergency or other personnel with a list of identified individuals; continuously updating the list of identified individuals; receiving information concerning individuals that should be added or removed from the list of identified individuals; and receiving and listing information concerning the known location and condition of individuals on the list of identified individuals.

In another preferred embodiment of the invention the method further comprises the step of verifying the information concerning individuals that should be added or removed from the list of identified individuals and adding or subtracting said individuals from the list.

In another preferred embodiment of the invention, the method further comprises the steps of receiving requests from users for updated information concerning one or more identified individuals and automatically communicating to users updated information.

### BRIEF DESCRIPTION OF THE DRAWINGS

These and other features, aspects, and advantages of the present invention will become better understood with regard to the following description, appended claims, and accompanying drawings where:

FIG. 1 is a schematic representation of the personnel accounting system comprising a central processing and communication system having a central computer, controller and processor and a memory that may be coupled to other devices;

FIG. 2 is a schematic representation of the central processing and communication system further including a communications server coupled to the central computer that operates to connect the system to various outside communication systems;

FIG. 3 is a schematic representation illustrating the general methodology and interactive method of the system software of the personnel accounting system;

FIG. 4 is a schematic representation illustrating the general methodology and interactive method of the personnel accounting system core of the system software;

FIG. 5 is a schematic representation illustrating the general methodology and interactive method of the emergency operations core of the system software;

FIG. 6 is a schematic representation illustrating the general methodology and interactive method of the reporting functions core of the system software; and

FIG. 7 is a schematic representation illustrating the general methodology and interactive method as to how the system software operates to compare previously inputted and stored information with new updated information.

### DETAILED DESCRIPTION OF THE INVENTION

The present invention provides a distinct advance in the state of the art. The personnel accounting system for efficiently accounting of individuals after or during an event, such as a natural disaster or during an emergency, preferably is a computer-aided system that operates to provide an improved communication system whereby individuals can be identified, tracked, monitored in real time using a central processing and communication system and collectively stores and manages information pertinent to individuals affected by the event. The system includes a central processing and communication system that operates to receive, store and update information concerning a defined location, including individuals at or believed to be at the defined location. During or after an event, such as a natural disaster, information stored in the system can be immediately accessed by authorized personnel. Such information can include the names of individuals believed to be in the defined location area and information concerning their expected location within the defined location area. As used herein, the defined location area refers to an area that authorized personnel, such as fire, police, civil defense, military, disaster relief, and other such authorities have defined as a location area requiring assistance. The personnel accounting system is connected through communications networks such that individuals inside and outside the defined location can access and input information into the system.

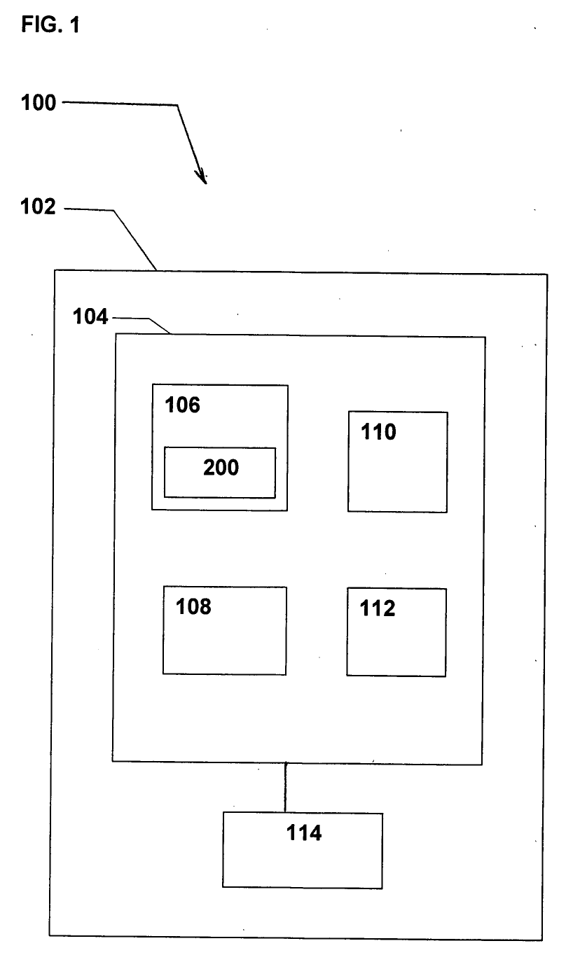

Referring to the drawings, as shown in FIG. 1, the system 100 for efficiently accounting of individuals during or after an event includes a central processing and communication system 102 comprising a central computer 104 having a controller and processor 106 and a memory 108 for maintaining one or more databases, all of which may be conventionally coupled to other devices, such as one or more suitable input devices 110, like a keypad, touch screen, and one or more suitable output devices 112, such as a computer display, printer, and the like. It should be understood that the central computer 104 can include any combination of the above components, or any number of different components, peripherals, and other devices. Preferably, the central computer 104 operates under the control of an operating system, such as the WINDOWS™ operating system developed by Microsoft Corporation or the Macintosh™ operating system developed by Apple Computer Corporation. It should be understood that other similar operating systems can also be used. The central computer 104 may also include input/output portals 114, such as those conventionally used for connecting to input/output Internet terminals, such as phone lines, wireless systems, and the like.

The controller and processor 106 of the central computer 104 operate the system software 200 that performs the main processing steps, as described herein below, of the system 100. The system software 200 is a computer-readable medium having computer-readable instructions for performing a method of operating the system to be displayed on the output devices 112 for use by individuals in inputting information into the system. Preferably, the system software 200 operates as an interactive, menu and event driven system that cooperates with the central computer 104 for using conventional type of prompt, dialog, and entry windows to guide a user to enter information. Thus, the system 100 provides an interactive communications interface for facilitating communications and information exchange between individuals and emergency organizations. As used herein, the term “software” refers to any form of programmed machine-readable language or instructions (e.g., object code) that, when loaded or otherwise installed, provides operating instructions to a machine capable of reading those instructions, such as a computer. The system software of the present invention can be stored or reside on, as well as be loaded or installed from, one or more floppy disks, CD ROM disks, hard disks or any other form of suitable non-volatile electronic storage media. The system software can also be installed by downloading or other form of remote transmission, such as by using Local or Wide Area Network (LAN or WAN)-based, Internet-based, web-based or other remote downloading or transmission methods.

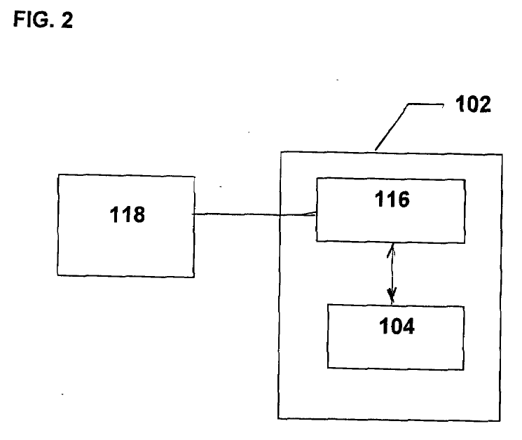

As shown in FIG. 2, in a preferred embodiment of the invention, the central processing and communication system 102 further includes a communications server 116 that is coupled to the central computer 104 such as through the input/output portals 114. The communications server 116 may include web servers, telephone servers, and the like, that operate to connect the system 100 to various outside communication systems 118, such as, but not limited to telephone systems, satellite systems, and outside networks, such as the Internet and other customer communication systems. In operation, information can be inputted into the system 100 for storage in a location database 120 contained within the memory 108 of the central computer 104 by users using an outside communication system 118. In another preferred embodiment information may be downloaded into the location database 120 using one or more floppy disks, CD ROM disks, hard disks or any other form of suitable non-volatile electronic storage media.

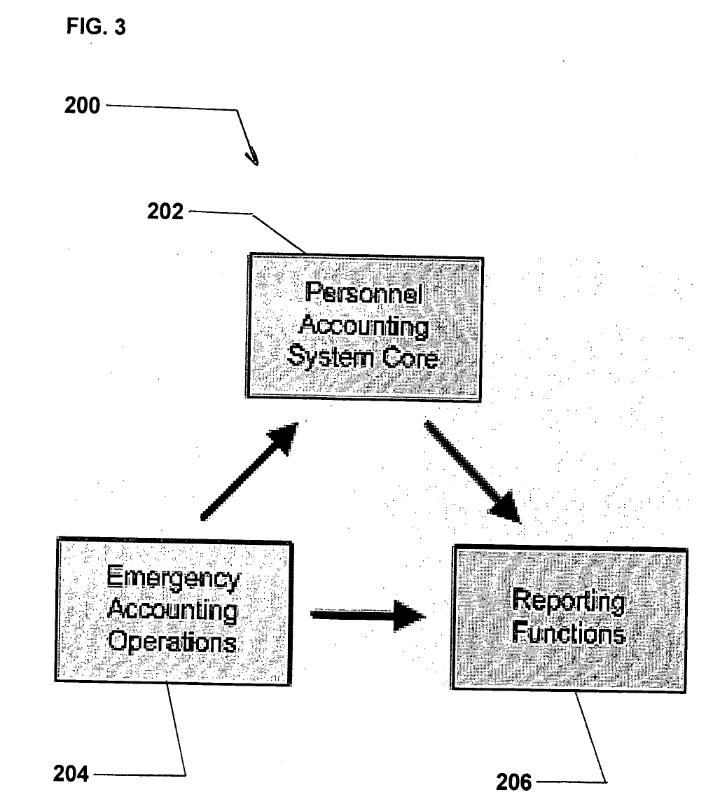

Referring to FIG. 3, the general methodology of the software 200 is shown and includes a system core 202 for performing routine database maintenance, including continuous updating; an emergency accounting operations core 204 and reporting functions core 206.

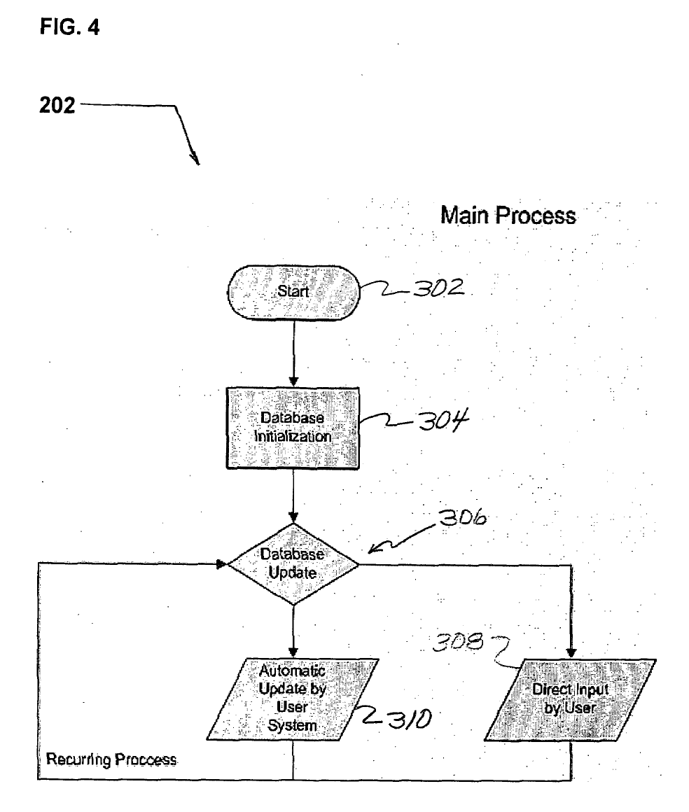

As shown in FIG. 4, the personnel accounting system core 202 of the system software 200 operates when activated or started (step 302) by the controller and processor 106 of the central computer 104. Once activated, a location database 120 which is stored within the memory 108 of the central computer 104 is initialized (step 304). The location database 120 is then continuously updated (step 306) either by direct input by an outside operator (user) (step 308) or by automatic updates (step 310). It should be understood that the location database 120 can include various information including, but not limited to, maps of the regions, names and addresses of businesses and individuals, emergency resources (police, fire, medical facilities, and the like), and possible emergency apparatus and systems (civil defense systems, food and water supplies, power systems, shelters, and the like).

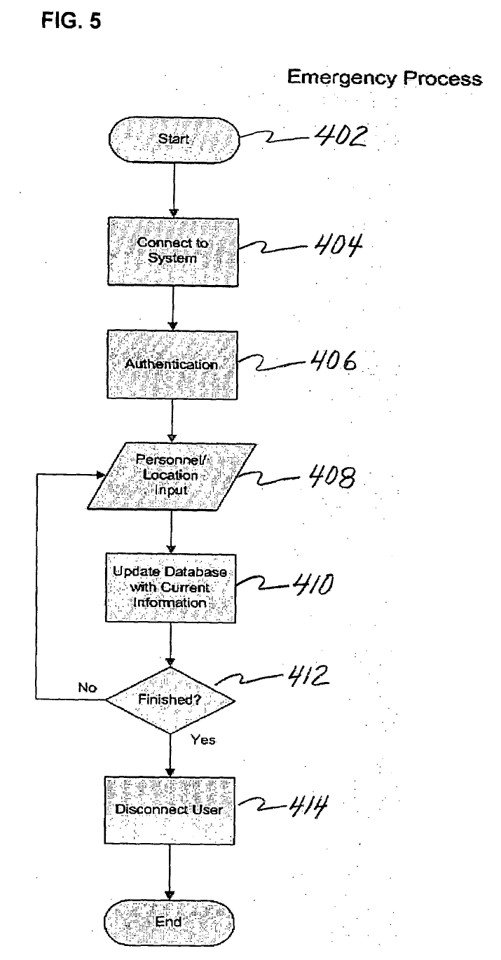

Referring to FIGS. 1 and 5, the emergency operations core 204 when activated or started (step 402), such as during or after an event, the controller and processor 106 of the central computer 104 operates to allow outside users and emergency users or workers to connect to the system (step 404) and input information concerning individuals into the system 100. When activated, the communications server 116 cooperates with outside communications systems 118 to place users into direct communication with the central computer 104 of the system 100 and through a serious of prompts and dialog boxes are asked to authenticate themselves by providing certain information, such as name, address, phone numbers, social security numbers, or other means of identification (step 406). Users can enter the necessary information using an input device, such as a keyboard or the like. The information is then directly entered and stored in an emergency database 122 contained within the memory 108 of the central computer 104. In the event that the user is using an input device, such a voice system, like a telephone, the central computer 102 will operate to direct the user to an operator a voice recognition system (IVR) that can receive the information from the individual and then input the information into the emergency database 122 using an input device 110. Once the individual is authentificated, the user is directed to enter information, such as location information into the system (step 408). The system software 200 then stores or updates already stored information into the emergency database 122 (step 410). Additional information can be added until finished (step 412) until disconnected by the user (step 414). It should be understood that the location database 120 can be used as the initial emergency database 122 for individuals located within a defined location area.

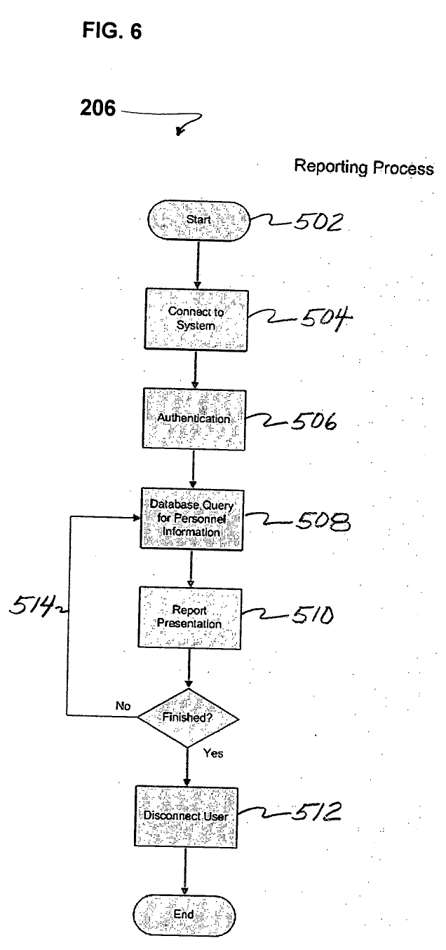

Referring to FIGS. 1 and 6, the reporting functions core 206, when activated or started (step 502), operates to allow the communications server 116 to cooperate with outside communications systems 118 to place users into direct communication with the central computer 104 of the system 100 (step 504). Through a serious of prompts and dialog boxes users are asked to authenticate themselves by providing certain information, such as name, address, phone numbers, social security numbers, or other means of identification (step 506). Users can enter the necessary information using an input device, such as a keyboard or the like. After the user has completed the authentication process, the reporting process core 206 operates to allow users using the outside communications system 118 to request and/or search for information contained in the emergency database 122 (step 508). The reporting function core 206 of the system software 200 then provides a report containing the information sought (step 510). The information can then be reviewed and the user can disconnect from the system (step 512) or can request additional information (step 514).

It should now understood that in operation, by activating and utilizing the emergency event accounting system one can maintain information about individuals, businesses, and resources and once an emergency or a disaster occurs and a location area defined, the system can be utilized to provide an improved communication system whereby individuals can be identified, tracked, monitored in real time using the central processing and communication system and to manage information pertinent to individuals affected by the event. Such information may be downloaded from address books, local, county and state records, school registrations, employment records, and the like, and preferably includes names, addresses, telephone numbers, maps, aerial photographs and other such information. Upon the occurrence of an emergency or disaster event, emergency personnel can activate the emergency operations core and use the information contained within the system to coordinate search and rescue operations. It should now be apparent that by utilizing the information search and rescue operations can be directed to find and rescue, if necessary, individuals believed to be in certain defined areas. Further, as individuals report to emergency shelters, hospitals, clinics, and the like, emergency personnel can download location and other pertinent information into the system memory, thereby allowing up-to-date information to be maintained. During an emergency or disaster event, individuals and emergency personnel can activate the reporting functions core to receive up-to-date information concerning individuals. In another preferred embodiment of the invention, information, such as maps, aerial photographs, and specific information can be transmitted and displayed on portable display systems, hand-held display systems, and the like, carried by or in the possession by emergency personnel, such as yhose in the event location area.

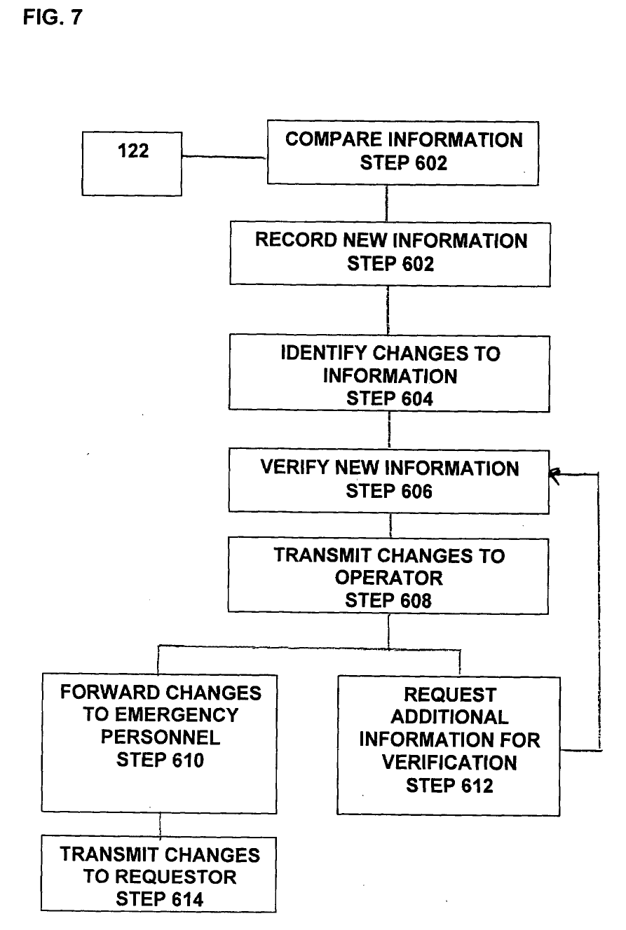

For an illustrative example of the operation of the system, during an event, individuals can be identified and their believed location can be provided to emergency personnel. In addition, special needs or concerns, such as the individuals age, medical condition, and the like, can be provided to emergency personnel. In addition, users, such as family members, friends, co-workers, employers, administrators (such as for an example, school administrators) can utilize the system to identify and possibly provide the location or other information, of individuals that are believed to be in the area (or known to have left the area). Referring to FIGS. 5 and 7, as information is inputted into the emergency database 122 (step 408), the system software 200 operates to compare the new information with the current stored information (step 602) and records the new information into the database 122 (step 410). Using conventional type of prompt, dialog, and entry windows to guide the user, the system software 200 identifies changes in the information (step 604). For an illustrative example, if stored information lists an individual to be located at a particular address or location within the defined location area, if the new information places the individual at a different location, the software identifies the change and requests from the user additional information that can be used to verify the new information (step 606). The new information, together with information provided by the user during the authentication process (step 406), is transmitted to emergency personnel or to a system operator (step 608) who than can forward the information to the proper personnel or agency (step 610). If necessary, the system operator or emergency personnel can contact the user who inputted the new information in order to obtain additional information or for information verification (step 612). If verified or accepted, in another preferred embodiment of the new information is forwarded to those requesting updates for one or more individuals (step 614). In another preferred embodiment of the personnel accounting system, individuals can input into the system for storage in the location database personal information, including, but not limited to addresses, phone numbers, listing of family members, medical conditions, and the like. The system then maintains the information for use in case of an event. In another preferred, individuals are provided with or submits a password that permits the individual access to the system for updating such personal information. In another preferred embodiment, the individual is provided with or submits a password that they can provide to family members, friends, and the like that can be used during or after an event for permitting them to receive information using the personnel accounting system. For an illustrative example, when an individual submits information to the system, the individual can request that only those having a certain password can receive information about the individual. Thus, during or after an event, a user requesting information (step 508) must input the correct password in order to receive the requested information (step 510). It should now be apparent that the personnel accounting system of the subject invention provides an efficient method of maintaining up-to-date and reliable information during or after the occurrence of an event. It should be appreciated that such a system can reduce the likelihood of rescue workers, emergency personnel, and the like spending critical time and effort to look for individuals at the wrong location or not in the defined location area, or the likelihood that individuals not normally in the defined location area being missed or not searched for by rescue or emergency workers and the like.

For another illustrative example of the operation of the system, during or after an event, such as a natural or man-caused disaster, various emergency organizations, including local, state, county and federal organizations often operate within the defined location area. Individuals are often taken to shelters, rescue or medical facilities, or other relief locations by any one of the emergency organizations. Individuals often get separated or are moved several times during a relatively short period of time. Accordingly, until now, it was not uncommon for individuals to be separated. Further, until now there has not been an effective system that provides an effective and easy method of tracking and monitoring individuals who have been transported to various relief locations. This becomes particularly troublesome when others, such as family members, attempt to find the location and condition of individuals believed to have been in the area of the emergency. Accordingly, relief organizations are often overwhelmed by inquires concerning such individuals. It should now be apparent that the system of the subject invention permits users, such as family members, to easily obtain information known at the time with regard to individuals believed to have been in the area of emergency.

In another preferred embodiment, as shown in FIGS. 6 and 7, during the authentication process (step 506), a user can input contact information, such as an Email address, phone number, and the like by which the user would like to receive automatic updates (step 614). When the user requests information (step 508), the user can also request that as information concerning one or more individuals is updated in the system, the user is automatically notified of the updated information (step 616). It should now be apparent that the subject system whereby automatic updates are transmitted to requested users significantly reduces the personnel and resources needed to communicate with the public, provides an efficient means for communicating information, and reduces the anxiety of concerned users.

Accordingly, the personnel accounting system of the subject invention provides means for creating a list of individuals and identifies those individuals that are expected to be at or near a defined location area; that permits on-going additions or subtractions from that list; that allows important information concerning such individuals to be readily available; allows the location and condition of individuals to be inputted and updated on an on-going basis; and permits users to obtain information about the location and condition of those that have or may have been at the defined location area.

We claim:

1. An personnel accounting system comprising:
a central processing and communication system for storing information concerning individuals;
means for identifying and listing individuals that may be within a defined location area;
means for transmitting said listing of individuals to emergency personnel;
means for continuously updating the information about individuals on said listing of individuals; and
means whereby users can request information concerning individuals on said listing of individuals;
means whereby users can add or subtract individuals on said listing of individuals.

2. The personnel accounting system of claim 1 wherein said central processing and communication system comprises a central computer having a controller and processor and memory for maintaining one or more databases;
wherein said central computer operates system software that functions as an interactive system for guiding a user to enter information and storing said information in one or more of said databases; and
wherein said system software operates to permit users to request information about individuals.

3. The emergency event accounting system of claim 1 wherein said system further comprises means for automatically communicating updates about one or more individuals to a user.

4. A personnel accounting system comprising:
a central processing and communication system comprising a central computer having a controller and processor and memory for maintaining one or more databases;
wherein said central computer operates system software that functions to receive information about individuals and electronically store said information in one or more of said databases;
wherein said system software identifies individuals listed to be within a defined location area;
wherein said system software functions as an interactive system for guiding a user to enter updated information about individuals and storing said information in one or more of said databases;
wherein said system software functions to compare information about identified individuals listed to be within a defined location area with updated information; and
wherein the system further comprising means for verifying said updated information.

5. The personnel accounting system of claim 4 further comprising means for permitting users to request updated information about one or more individuals.

6. The personnel accounting system of claim 5 further comprising means for communicating updated information to the users requesting updated information about one or more individuals.

7. A personnel accounting system comprising:
a central processing and communication system comprising a central computer having a controller and processor and memory for maintaining one or more databases;
a communications server coupled to said central computer that operates to connect the system to one or more outside communication systems;
wherein said processor being capable of performing the following operations:
initializing a location database, wherein the location database includes a listing of individuals and the location of said individuals;
continuously updating of said location database;
identifying and preparing a listing of individuals within a defined location area;
receiving new information concerning individuals and adding or subtracting individuals to the listing of individuals;
receiving request for information for individuals on said listing of individuals;
and providing and transmitting said requested information.

8. The system of claim 7 wherein said processor further being capable of performing the operation of verifying said new information.

9. The system of claim 7 further comprising means for automatically transmitting updated information to a requester.

10. A method of accounting for the accounting of individuals after or during an event, the method comprises the steps of:
receiving information concerning an event;
defining an event location area;
identifying individuals from a listing of individuals who may be in the event location area;
providing emergency personnel with a list of identified individuals;
continuously updating the list of identified individuals;
receiving information concerning individuals that should be added or removed from the list of identified individuals;
receiving and listing information concerning the known location and condition of individuals on the list of identified individuals.

11. The method of claim 10 further comprising the step of verifying the information concerning individuals that should be added or removed from the list of identified individuals and adding or subtracting said individuals from the list.

12. The method of claim 10 further comprising the steps of receiving requests from users for updated information concerning one or more identified individuals and automatically communicating to users updated information.
